(19) United States
(12) Patent Application Publication
(10) Pub. No.: US 2014/0091664 A1
(43) Pub. Date: Apr. 3, 2014

(54) INTERIOR PERMANENT MAGNET ELECTRIC ROTATING MACHINE

(71) Applicant: SUZUKI MOTOR CORPORATION, Shizuoka (JP)

(72) Inventor: Masahiro AOYAMA, Shizuoka (JP)

(73) Assignee: SUZUKI MOTOR CORPORATION, Shizuoka (JP)

(21) Appl. No.: 14/031,226

(22) Filed: Sep. 19, 2013

(30) Foreign Application Priority Data
Sep. 28, 2012 (JP) 2012-217463

(51) Int. Cl. H02K 1/27

(52) U.S. Cl. CPC H02K 1/274
USPC 310/156.53

(57) ABSTRACT

An electric rotating machine comprises a stator adapted for receiving stator windings; a rotor rotatable relative to the stator; permanent magnets in the rotor forming magnetic poles; and apertures with a low permeability. Each aperture is for that portion of one of the permanent magnets located in a predetermined range which would generate magnetic flux lines in such directions as to cancel magnetic flux lines emanating from the stator in the neighborhood of a direct axis of one of the magnetic poles if the permanent magnet were located in the predetermined range.

### CROSS REFERENCE TO RELATED APPLICATION

The present application claims priority to Japanese Patent Application No. 2012-217463, filed on Sep. 28, 2012, the entire contents of which are hereby incorporated by reference for all purposes.

### TECHNICAL FIELD

The present invention relates to an interior permanent magnet (IPM) electric rotating machine, more specifically, an IPM electric rotating machine with highly efficient operation in a motoring mode.

### BACKGROUND

Electric rotating machines need to provide various output characteristics so as to meet different demands by apparatuses which they are applied to. If, for example, an electric rotating machine is to perform the function of a traction motor, in a hybrid electric vehicle (HEV: Hybrid Electric Vehicle), as a power source in cooperation with an internal combustion engine or, in an electric vehicle (EV: Electric Vehicle), as a single power source, the traction motor needs to operate at variable speed in a motoring mode over a wide speed range and to provide sufficiently high torque at low speeds.

In the vehicles of the above kind, an improvement in fuel efficiency demands an improvement in energy conversion efficiency of each of components including an electric rotating machine, specifically an improvement in efficiency in a commonly used area in the case of an onboard electric rotating machine. Further, the onboard electric rotating machine needs to have a more compact and high energy density construction from the perspective of restrictions on its installation space and from the perspective of miniaturization.

Incidentally, in HEVs or EVs, generally, an electric rotating machine operates at low speeds under low load conditions in a normal motoring mode. For this reason, there is a tendency to use strong permanent magnets for high efficiency because magnet torque contributes more to generation of torque for the onboard electric rotating machine than reluctance torque, which is variable with the amplitude of currents through stator windings.

Such tendency is seen in growing use of a synchronous motor of the permanent magnet type including a neodymium magnet with a high remanence embedded in a magnetic core, called an interior permanent magnet (IPM) synchronous motor. In such IPM electric rotating machine, it is proposed to embed permanent magnets in a rotor in such a way that the permanent magnets are located in a “V” shape configuration opening towards a rotor outer surface in order to create a magnetic circuit capable of positively utilizing reluctance torque as well as magnetic torque (see Patent Literature 1, i.e. JP-A 2006-254629 which is also published as US 2008/0258573 A1, and Patent Literatures 2, i.e. JP-A 2008-104323 which is also published as US 2008/0093944 A1).

### PRIOR ART

[Patent Literature 1]JP-A 2006-254629

[Patent Literature 2]JP-A 2008-104323

Incidentally, in recent electric rotating machines, permanent magnets, which contain such rare earth elements as Nd, Dy and Tb, come into increasing use in order to heighten magnetism and heat-resistance, but soaring prices, which are caused by their scarcity and the instability of their distribution, cause a growing need to improve the efficiency with a reduction in usage of such rare earth elements.

However, since, in HEVs and EVs, the commonly used area is a low speed low load area of an electric rotating machine, there is a tendency to increase the usage of permanent magnets with high magnetism in order to increase magnet torque that contributes to power rotation in such area. This approach is in a direction away from the achievement of the task of a reduction in the usage of rare earth elements.

### SUMMARY

Therefore, an object of the present invention is to provide a low cost high energy density electric rotating machine implementing high efficient operation in a motoring mode while reducing the usage of permanent magnets.

According to a first aspect, there is provided an interior permanent magnet (IPM) electric rotating machine, comprising:

a stator adapted for receiving stator windings;

a rotor rotatable relative to the stator;

permanent magnets in the rotor forming magnetic poles; and

apertures with a low permeability, each being substituted for that portion of one of the permanent magnets located in a predetermined range which would generate magnetic flux lines in such directions as to cancel magnetic flux lines emanating from the stator in the neighborhood of a direct axis of one of the magnetic poles if the permanent magnet were located in the predetermined range.

According to a second aspect, in addition to the special technical feature of the first aspect, when a slot per phase per pole value P is 2, q=2, the rotor is selected to satisfy the equality expressed as:

1.38≦(P×Wₚₘ)/R<1.84,

where; Wₚₘ is the dimension of each of said permanent magnets in radial direction of said rotor, R is the radius of said rotor to its periphery and P is the slot per phase per pole value.

According to the first aspect, since each aperture is substituted for that portion of one of the permanent magnets located in a predetermined range which would generate magnetic flux lines in such directions as to cancel magnetic flux lines emanating from the stator in the neighborhood of a direct axis of one of the magnetic poles if the permanent magnet were located in the predetermined range, magnetic flux lines generated by permanent magnets (called “magnetic rotor flux”) do not act against (cancel) magnet flux line generated by stator windings (called “magnetic stator flux”) in the neighborhood of the direct axis, and the passage of the magnetic stator flux through the predetermined range is restricted. Therefore, both magnet torque and reluctance torque are used effectively by eliminating magnetic rotor flux which would wastes magnet stator flux in the neighborhood of the direct axis, and the usage of permanent magnets is reduced while obtaining torque equal to or greater than before substituting an aperture for the direct axis side portion of each of permanent magnets.

Furthermore, substituting the aperture for the portion of the permanent magnets improves output power at high speeds because a reduction in permanent magnet flux causes a reduction in induced voltage constant. A reduction in weight of permanent magnets causes a reduction in inertia.

A reduction in magnetic rotor flux causes a reduction in space harmonics which cause magnetostriction because of a reduction in field weakening area (a reduction in amount of field weakening). This restrains generation of heat by controlling generation of eddy current, and restrains demagnetization caused by temperature change of permanent magnets to provide a low cost by lowering heat resistant grade.

According to the above mentioned second aspect, since, in the case of the structure in which a slot per phase per pole value q is 2, the rotor is selected to satisfy the equality that a ratio that [(a pole number P)×(a dimension of permanent magnet Wₚₘ)]/R is made greater than or equal to 1.38 but less than 1.84, the usage of permanent magnets is reduced more than the case in which the permanent magnets are positioned to extend as far as the side of the direct axis. In particular, the usage of permanent magnets is reduced by 24.7% at the value 1.38 while obtaining the maximum torque equal to or greater than before.

### BRIEF DESCRIPTION OF THE DRAWINGS

FIG. 1 is a plan view of a rotor and a stator of an IPM electric rotating machine embodying features of the invention.

FIG. 2 is a diagrammatic view of a rotor embodying features of the invention, wherein the stator has energized stator windings with electrical current, but wherein the permanent magnets are not included, the magnetic flux lines (ψᵣ) being generated solely by the energized stator windings, not illustrated, during operation under low load conditions in a motoring mode.

FIG. 3 is a view similar to FIG. 2, wherein the stator has no current, the magnetic flux lines (ψₘ) from the north poles (N) to the south poles (S) being generated by permanent magnets received in magnet openings in the rotor only during operation under low load conditions in a motoring mode.

FIG. 4 is a plot showing torque characteristics versus various degrees of phase of current for a V type IPM motor including a conventional rotor formed with an aperture that is not large located on the direct axis side of each of permanent magnets.

FIG. 5A is a diagrammatic view of the conventional rotor, wherein the stator has no current, the magnetic flux lines (ψₘ) being generated by permanent magnets only, which are received in magnet openings in the rotor.

FIG. 5B is an enlarged view of an area in the neighborhood of each of direct axes of the rotor shown in FIG. 5A, indicating a vector field (Vₘ) developed by the magnetic flux lines generated by the permanent magnets only.

FIG. 6A is a view similar to FIG. 5A, wherein the stator has energized stator windings with electrical current, but wherein the permanent magnets are not included, the magnetic flux lines (ψᵣ) being generated solely by the energized stator windings during operation under maximum load in a motoring mode.

FIG. 6B is an enlarged view of an area in the neighborhood of each of direct axes of the rotor shown in FIG. 6A, indicating a vector field (Vᵣ) developed by the magnetic flux lines generated solely by energized stator windings.

FIG. 7 is a diagram of a model illustrating a relationship of the vector distribution by permanent magnets of each pair forming one magnetic pole relative to the vector distribution by the energized stator windings within an area on the outer periphery side of the magnetic pole of the conventional rotor shown in FIG. 5A during operation under maximum load in a motoring mode.

FIG. 8 is a plot showing correspondence of torque with phase of input current to the V type IPM motor including the rotor shown in FIG. 5A.

FIG. 9 is a view similar to FIGS. 5A and 6A, wherein the magnetic flux lines (ψᵣ) are generated solely by the energized stator windings during operation under low loads in a motoring mode.

FIG. 10 is a view similar to FIGS. 5A, 6A and 9, but which includes flux-flow paths defined by flux-flow distribution of synthetic magnetic flux lines (Ωₛ) developed by the combined effect of magnetic flux lines (ψₘ) generated by the permanent magnets and magnetic flux lines (ψᵣ) generated by the energized stator windings in addition to the synthetic magnetic flux lines (ψₛ) during operation under low loads in a motoring mode.

FIG. 11 is a chart showing the variation of output torque and the reducing rate of torque ripple if each of the embedded permanent magnets is shortened in a rotor embodying features of the invention.

FIG. 12 is a chart showing the variation of 5^{th} order space harmonic if each of the embedded permanent magnets is shortened in the rotor embodying the features of the invention.

FIG. 13 is a chart showing a comparison of percentages of torques generated when the conventional rotor shown in FIGS. 5A, 6A and 9 is used during operation under low loads in a motoring mode, with respect to percentages of torques when the rotor embodying the features of the invention is used during operation under low loads in a motoring mode.

FIG. 14 is a chart similar to FIG. 13, but which shows a comparison of torques generated when the conventional rotor shown in FIGS. 5A, 6A and 9 is used during operation under maximum load in a motoring mode, with respect to percentages of torques when the rotor embodying the features of the invention is used during operation under maximum load in a motoring mode.

FIG. 15 is a view similar to FIG. 2, wherein the stator has energized stator windings with electrical current, but wherein the permanent magnets are not included, the magnetic flux lines (ψᵣ) being generated solely by the energized stator windings, not illustrated, during operation under maximum loads in a motoring mode.

FIG. 16 is a view similar to FIGS. 2 and 15, but which includes synthetic magnetic flux lines (ψₛ) developed by the combined effect of magnetic flux lines generated by the permanent magnets and magnetic flux lines generated by the energized stator windings during operation under low loads in a motoring mode.

FIG. 17 is a view similar to FIGS. 2, 15 and 16, but which includes synthetic magnetic flux lines (ψₛ) developed by the combined effect of magnetic flux lines generated by the permanent magnets and magnetic flux lines generated by the energized stator windings during operation under maximum load in a motoring mode.

### DETAILED DESCRIPTION

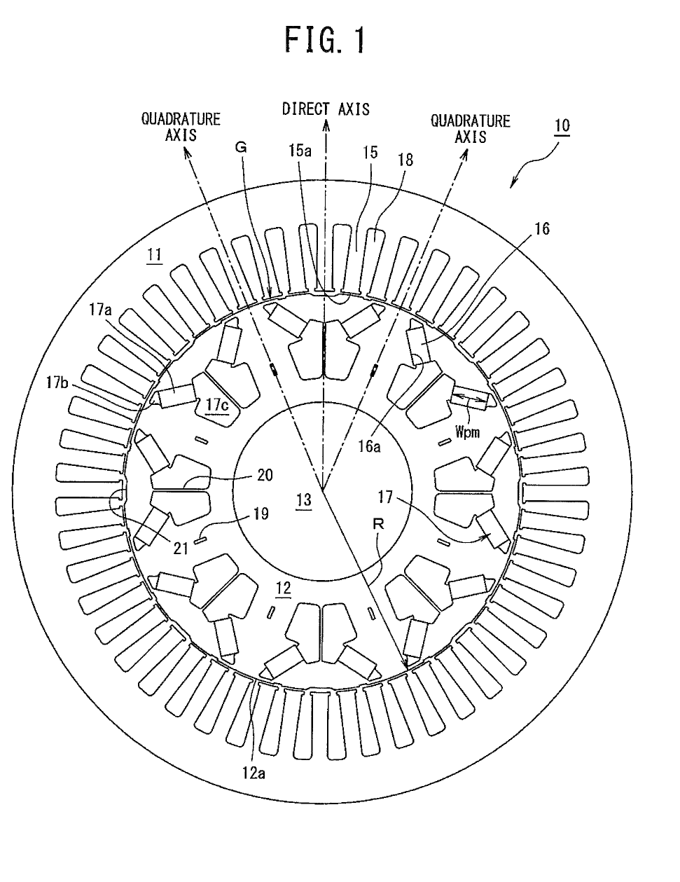

Referring to the accompanying drawings, embodiment(s) according to the present invention are described. FIGS. 1 to 17 show one embodiment of an IPM electric rotating machine according to the present invention. In the following description of the present embodiment, a rotor rotates in such a direction that, for example, rotates with respect to a stator in a counterclockwise (CCW: counterclockwise) direction for illustration purpose only.

In FIG. 1, an electric rotating machine (or motor) 10 comprises a stator 11 shaped in the form of a generally cylindrical configuration and a rotor 12, surrounded by this stator 11, rotatable on an axis of rotation or a rotor axis and fixedly coupled to a rotating drive shaft 13 that is arranged coaxially with the axis of rotation. This electric rotating machine 10 yields performance conformed to specifications required as a power source by a hybrid electric vehicle (HEV) or an electric vehicle (EV) as an internal combustion engine is required as a power source by a vehicle or specifications required as an onboard power source within each of traction wheels of a vehicle.

Stator 11 is formed with a plurality of stator teeth 15 extending in radial directions from the rotor axis in such a way that an inner periphery 15a of stator 11 and an outer periphery 12a of rotor 12 face each other with a gap G located between them. Stator 11 is wound with three-phase windings, each in distributed winding under one phase (not illustrated), to constitute stator windings capable of generating magnetic flux that interacts with rotor 12 to create rotor torque.

Rotor 12 is made as a rotor of an IPM (Interior Permanent Magnet) motor and has embedded therein multiple sets of permanent magnets 16, each set having a pair of permanent magnets 16 per one pole located in a “V” shape configuration opening toward the outer periphery 12a. For permanent magnets 16 of each pair, the rotor 12 is formed with a set of openings 17 located in “V” shape configuration opening toward the outer periphery 12a to fixedly receive the permanent magnets 16, each having the same rectangular cross sectional profile throughout its length and extending axially along the rotor axis, by allowing their corners 16a to be inserted into the set of openings 17.

The openings 17 of each set located in “V” shape configuration include magnet openings 17a, which are configured to receive and encase the permanent magnets 16 of the corresponding one pair, and apertures 17b and 17c, which are located across each of the permanent magnets 16 and separated from each other in the direction of its width and serve as flux barriers to restrict magnetic flux turning around the permanent magnet 16 (called hereinafter “flux barriers” 17b and 17c). Each set of openings 17 located in “V” shape configuration has a center bridge 20 that extends between the apertures 17c located between the permanent magnets 16 of each pair, in a radial direction from the rotor axis, to interconnect the aperture defining outer and inner edges in order to hold the permanent magnets 16 in position against centrifugal force created when the rotor 12 spins at high speeds.

In this electric rotating machine 10, openings, each between the adjacent two of the stator teeth 15 of the stator 11, constitute slots 18, in which stator windings are inserted to form coil groups around the stator teeth 15. On the other hand, each of eight sets of the permanent magnets 16 on rotor 12 faces the corresponding six of the stator teeth 15 of stator 11. In short, this electric rotating machine 10 is configured such that each pole constituted by one pair of permanent magnets 16 on rotor 12 faces the adjacent six of the slots 18 of stator 11. This means that electric rotating machine 10 is made as a three-phase IPM motor, in which the two face-to-face sides of a pair of magnets in every other magnetic pole have the north poles, while the two face-to-face sides of a pair of magnets in the adjacent magnetic pole have the south poles, and a 48-slot stator is wound in distributed winding to form coils, each having a coil pitch in electrical angles for five stator teeth, under each phase to form 8 magnetic poles (4 pairs of magnetic poles). In other words, electric rotating machine 10 is made as a construction of the IPM type, in which (a slot per phase per pole value q)={(a slot number)/(a pole number)}/(a phase number)=2.

This enables the rotor 12 to operate in a motoring mode by energizing the stator windings received in slots 18 of stator 11 to generate magnetic flux lines extending in radially inward directions from the stator teeth 15 into the facing rotor 12. In this instance, with electric rotating machine 10 (stator 11 and rotor 12), a reluctance torque pointed to shorten the flux-flow path is combined with a magnetic torque derived from attractive and repulsive forces between permanent magnets 16 to create a composite rotary torque. Therefore, electrical energy generated by a current input to the stator windings is taken as mechanical energy out of a driveshaft 13 rotatable with rotor 12 relative to stator 11.

Each of stator 11 and rotor 12 comprises multiple laminations arranged in stacked relationship. Each of the laminations is formed of electrical steel such as silicon steel. The laminations are axially stacked by fasteners 19 to an appropriate axial thickness to a desired output torque.

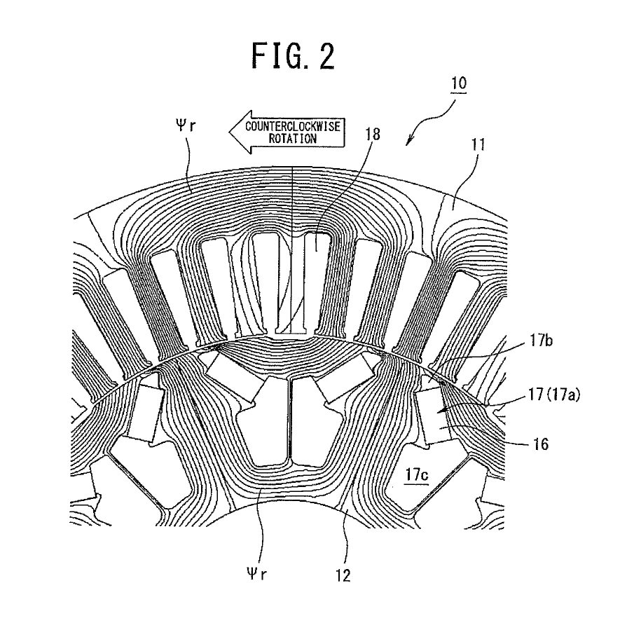

The electric rotating machine 10 has a coil group for each phase received in slots 18 in distributed winding per a set of stator teeth 15 facing a pair of permanent magnets 16 forming one magnetic pole in such a way that, as illustrated in FIG. 2, a flux-flow distribution created by the energized stator windings defines a flux-flow path (of magnetic flux lines generated solely by the energized stator windings) extending radially inward through the stator 11 between the slots 18, after travelling in a circumferential direction near the outer periphery of the stator 11, i.e. behind the set of stator teeth 15, to enter and extend through the rotor 12. The permanent magnets 16 of each pair are received in the magnet openings 17a of one set of openings 17 located in “V” shape configuration, which are formed along the flux-flow path of magnetic flux lines ψᵣ generated solely by the energized stator windings or, in other words, not to prevent build-up of such magnetic flux lines ψᵣ. The magnetic flux lines ψᵣ may be called “magnetic stator flux ψᵣ”.

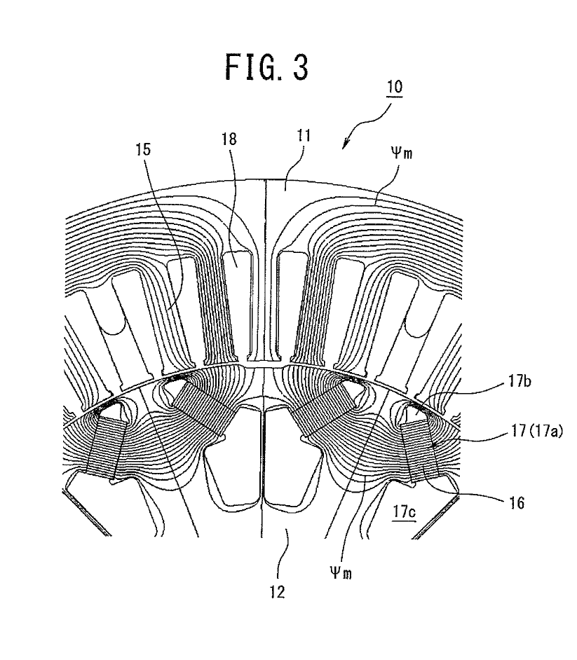

Flux-flow paths (of magnetic flux lines ψₘ generated by permanent magnets only) defined by a flux-flow distribution, as illustrated in FIG. 3, created by the permanent magnets 16 only extend perpendicularly from the north poles (N poles) on one sides of permanent magnets 16 of each pair forming one magnetic pole and enter perpendicularly the south poles (S poles) on opposite sides of the permanent magnets 16. In particular, after entering the stator 11 from the corresponding stator teeth 15, each of the flux-flow paths travels in a circumferential direction near the outer periphery of the stator 11. The magnetic flux lines ψₘ may be called “magnetic rotor flux ψₘ”.

In the IPM construction in which permanent magnets 16 of each pair are embedded in rotor 12 and located in “V” shape configuration, a direction of flux lines formed by each of magnetic poles, i.e. a center axis between the permanent magnets 16 of each pair located in “V” shape configuration, is referred to as a direct axis (d-axis), and a center axis, showing electric and magnetic orthogonality to the direct axis, between adjacent permanent magnets 16 between adjacent magnetic poles is referred to as a quadrature axis (q-axis). In the rotor 12, radially inner apertures 17c located on the direct axis sides of each set of openings 17 located in “V” shape configuration extend radially inward toward the rotor axis and configured to perform the function of flux barriers 17c.

In this electric rotating machine 10, this enables flux lines ψᵣ generated by stator windings, which have entered the rotor 12 in radial inward directions from stator teeth 15, travel further inward near the inner periphery (the rotor axis) in a way not to enter the radially outward region of the openings 17 of each set located in “V” shape configuration before returning to the stator teeth 15 as illustrated in FIG. 2. In a word, the electric rotating machine 10 is made as a V type IPM motor including a rotor 12 formed with apertures near the direct axes.

Further, in order to prevent saturation of the density of magnetic flux lines ψᵣ entering rotor 12 in a radial inward direction from that one of stator teeth 15 which comes into a radial alignment with a direct axis for each of the rotor poles, the electric rotating machine 10 includes a center groove 21 formed in the outer periphery of rotor 12 and located on the direct axis for the rotor pole, the center groove 21 lying opposite to inner periphery 15a of the aligned one of stator teeth 15 in parallel relationship and extending in the same direction as the stator tooth 15 does (in a direction along the rotor axis).

In electric rotating machine 10 with IPM structure embedding permanent magnets 15 in “V” shape configuration within rotor 12, torque T may be expressed by the following equation (1) as:

T=Pₚ{ψₘi_{q}+(L_{d}−L_{q}) i_{d} i_{q}} (1)

where

Pₚ: number of pole pairs, ψₘ: flux lines by magnets interlinked with stator (stator teeth 15),

i_{d}: direct-axis current, i_{q}: quadrature-axis current,

L_{d}: direct-axis inductance, and L_{q}: quadrature-axis inductance.

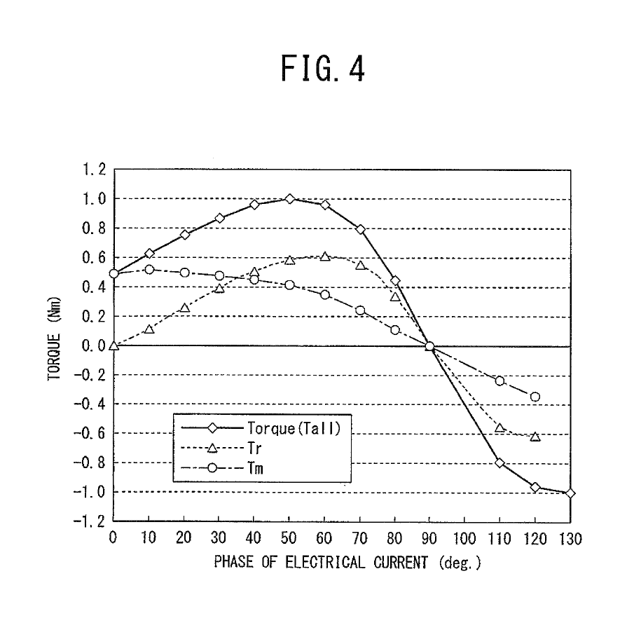

As shown in FIG. 4, high torque high efficient operation of electric rotating machine 10 is provided by operation with the current phase, at which the sum of magnet torque Tₘ and reluctance torque Tᵣ becomes the maximum.

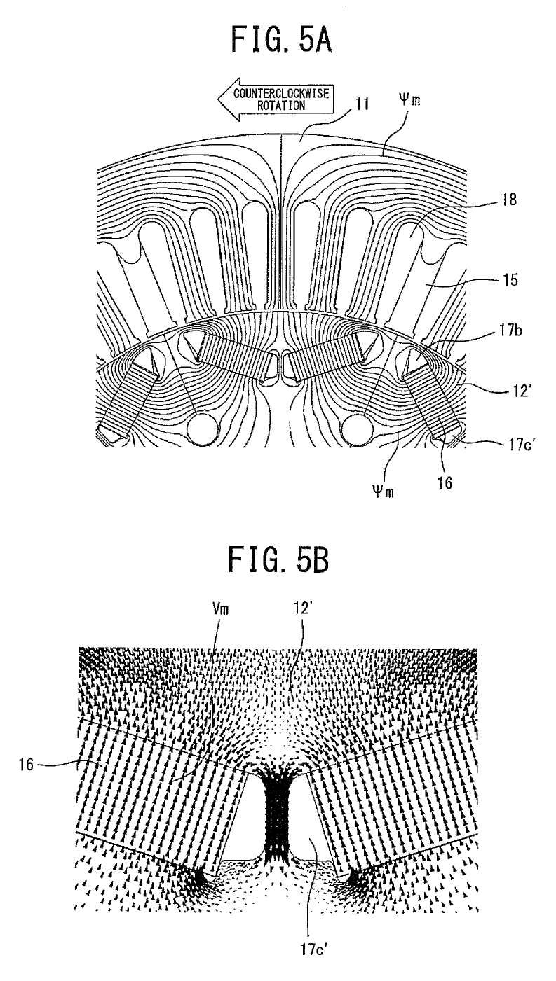

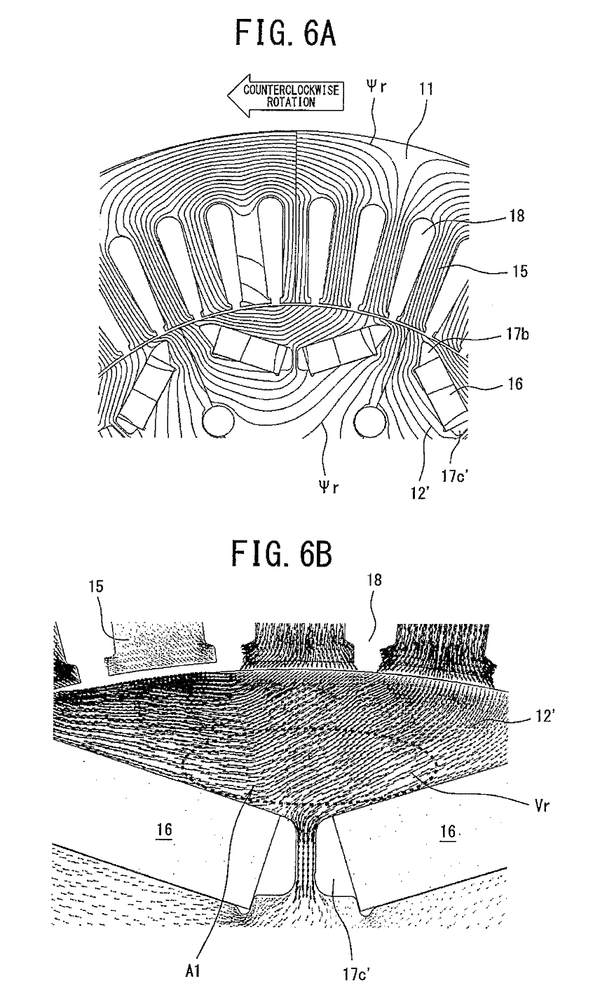

Referring to FIGS. 5A to 6B, in the case of a comparative rotor 12A according to the associated technology, the flux barriers 17c (see FIGS. 1 to 3) in the form of apertures located on the direct axis side are replaced by flux barriers 17d. The flux barriers 17d are generally identical, in shape dimensions, to flux barriers 17b located on the radially outer sides of openings 17 of each set located in “V” shape configuration. With regard to the comparative rotor 12A, flux-flow paths by permanent magnets 16 are defined by a flux-flow distribution illustrated in FIG. 5A. Magnetic flux lines ψₘ generated by magnets define vectors Vₘ having directions as indicated by a vector field of FIG. 5B. In addition, magnetic flux lines ψᵣ generated by energized stator windings received in slots 18 are indicated by a flux-flow distribution illustrated in FIG. 6A and define vectors Vᵣ having directions as indicated by a vector field of FIG. 6B.

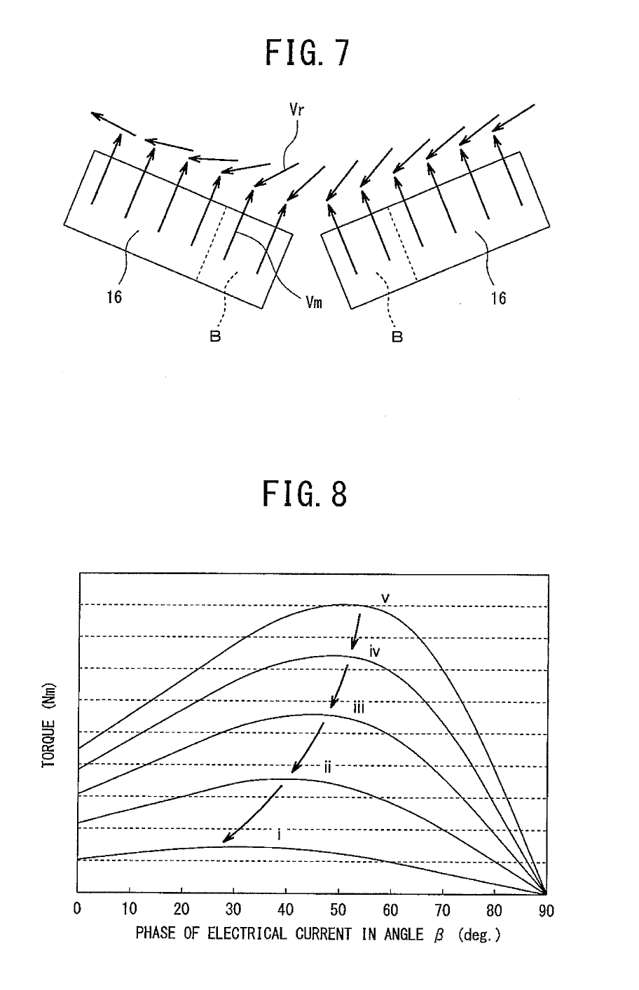

The electric rotating machine including the rotor 12A of the above-mentioned kind is operated by advancing an angle of phase of current under maximum load in a motoring mode to produce high torque at high efficiency. Under this condition, the rotor 12A according to the associated technology is being operated in a state in which magnetic flux lines ψₘ by magnets and magnetic flux lines ψᵣ by stator windings create opposing fields within a small region A1 (see FIG. 6B) located radially outward of the set of openings 17 located in “V” shape configuration and in the neighborhood of the direct axis, so reluctance torque Tᵣ offsets (countervails) magnet torque Tₘ as indicated by the illustrated vector fields in FIGS. 5B and 6B. In short, as shown in FIG. 7, this small region A1 is an interaction region where magnetic flux lines ψₘ by magnets and magnetic flux lines ψᵣ by stator windings act against each other with an induced angle equal to or greater than 90 degrees, so magnetic flux lines ψᵣ by stator windings are wasted by acting against (or cancel) magnetic flux lines ψₘ by magnets emanating from those ranges B, located near the direct axis, of permanent magnets 16 of each pair which are contiguous to the small region A1 located radially outward of the set of openings 17 located in “V” shape configuration.

For this reason, it may be said that since the ranges B, near the direct axis, of permanent magnets 16 fail to make any substantial positive contribution to production of torque T, it is possible to reduce the usage of permanent magnets 16 per se by cutting down the volume of the ranges B, near the direct axis, of permanent magnets 16 while keeping a saliency ratio in magnetic circuit as high as the previous saliency ratio.

Now, if the usage of permanent magnets 16 is reduced, the torque T, expressed by the previously mentioned equation (1), is kept as high as the previous torque produced before the usage of permanent magnets is reduced by increasing reluctance torque Tᵣ. This reluctance torque Tᵣ is increased by increasing a difference between the direct axis inductance L_{d} and the quadrature axis inductance L_{q}, that is, by increasing a saliency ratio.

Therefore, according to the present embodiment of rotor 12, the torque T is kept as high as the previous torque by substituting an aperture having a low magnetic permeability (called a “restricted area”) for each of the ranges B, near the direct axis, of permanent magnets 16 to increase a saliency ratio with a reduction in the usage of permanent magnets 16. Looking this from a different angle, the reluctance torque Tᵣ is increased by effectively using that portion of magnetic flux lines ψᵣ by stator windings which is used to be wasted by acting against magnetic flux lines ψₘ by stator windings emanating from the ranges B located near the direct axis so that torque T remains unchanged even though the usage of permanent magnets 16 is reduced.

Torque T is also expressed by the following equation (2). The proportion of magnet torque Tm becomes high under low load conditions where the amplitude of current Iₐ is decreased. As shown in FIG. 8, the lower the amplitude of current Iₐ, the more the phase angle of current β at which torque is the maximum approaches zero. The illustrated waveforms i, ii, iii, iv and v in FIG. 8 are characteristic curves, each showing the relationship between torque and phase angle of current at one of various amplitudes of current Iₐ(i), Iₐ(ii), Iₐ(iii), Iₐ(iv) and Iₐ(v), where the amplitudes of current have the relationship by the following inequity equation: i<ii<iii<iv<v. Therefore, though the proportion of (i.e., the dependence on) magnet torque Tₘ is naturally high during operation under low load conditions, it is desirable to make a magnetic circuit that maximizes effective use of such magnet torque Tₘ.

$$T = {P}_{p} \{ {ψ}_{m} {I}_{a} cos β + \frac{1}{2} ( {L}_{d} - {L}_{q} ) {I}_{a}^{2} sin 2 β \} \qquad ( 2 )$$

where β is the phase angle of current, and Iₐ is the amplitude of phase current.

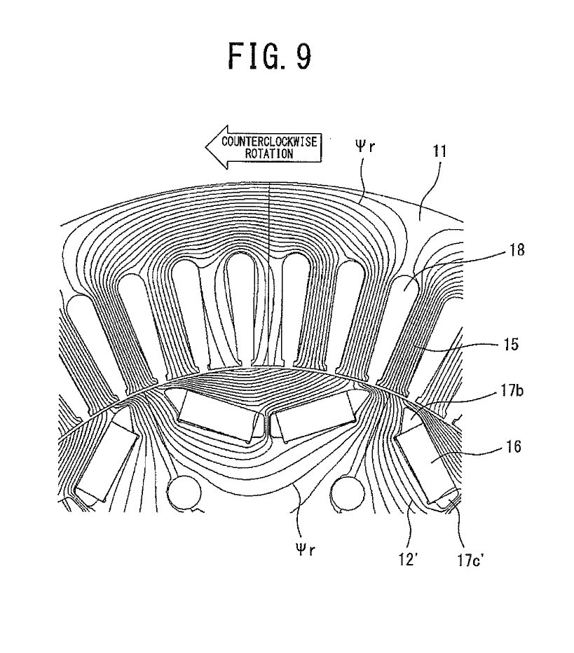

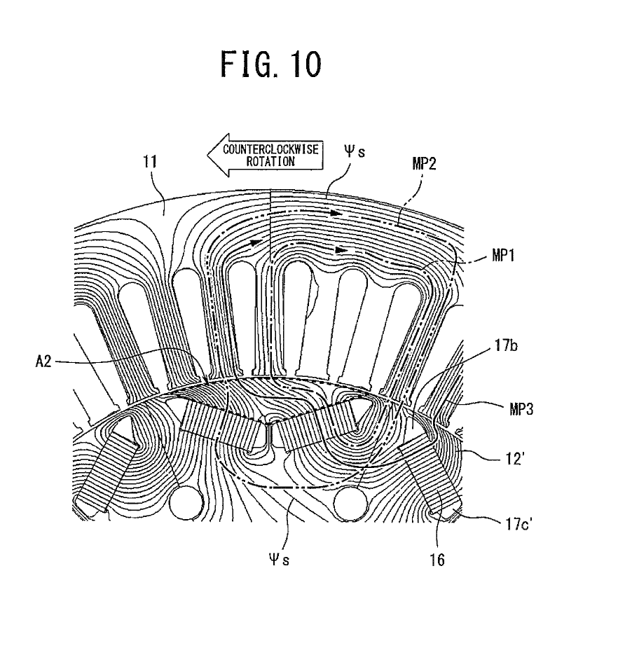

As shown in FIG. 9, with the rotor 12A according to the associated technology, the magnetic flux lines ψₘ by stator windings increase in number at each of quadrature axes between the adjacent two magnetic poles (between permanent magnets 16 of the adjacent two different magnetic poles) because the phase angle of current β is close to zero during operation under low load conditions with low amplitude of current. To address this, it is ideal for a magnetic circuit to pass through flux-flow paths MP1 and MP2 as shown in FIG. 10 as the route of superimposed flux lines ψₛ developed by the combined effect of magnetic flux lines 16 by magnets and the above-mentioned magnetic flux lines ψᵣ by stator windings. This will enable positive utilization of reluctance torque Tᵣ because the superimposed magnetic flux lines ψₛ increases quadrature-axis inductance L_{q} along each of quadrature axes by distributing quadrature-axis flux-flow path (magnetic flux lines through the quadrature axis), which extend along the quadrature axis (without inducing any saturation).

The flux-flow path MP1, after entering the rotor 12A at an interpolar portion between the adjacent two magnetic poles via air gap G from one of stator teeth 15 in interlinking relationship, turns in a direction toward the adjacent one of a pair of permanent magnets 16 forming a leading one of the two magnetic poles (the left side viewing in FIG. 10) with respect to rotor's rotating direction and passes through it from its side near the inner periphery of the rotor 12A. The flux-flow path MP1 then traverses the outer peripheral region A2 of the magnetic pole and returns to another one of the stator teeth 15 via air gap G again.

The flux-flow path MP2, after entering rotor 12A at the interpolar portion in the same manner as the flux-flow path MP1, turns in a circumferential direction toward the remote one of the permanent magnets 16 forming the leading one of the two magnetic poles with respect to rotor's rotating direction and passes through it from its side near the inner periphery of the rotor 12A. The flux-flow path MP2 then traverses the outer peripheral region A2 of the magnetic pole and returns to the stator tooth 15 via the air gap G again.

Referring to FIG. 10, if the permanent magnets 16 of each pair are localized inwards toward the rotor axis by having portions removed inwards from their remotest both ends (pole's radially outer ends), the flux-flow paths MP1 and MP2 fail to effectively use the entirety of outer peripheral region A2 of the magnetic pole because large flux barriers contiguous to the remotest both ends of the permanent magnets of the pair concentrate on the neighborhood of the middle of the magnetic pole, making it difficult for the flux-flow paths to extend through, in particular, the right-sided half of the outer peripheral region A2.

On the other hand, if the permanent magnets 16 of the pair are localized outward by having portions removed inwards from their nearest ends (radially inner ends of the magnetic pole) near the center axis of the permanent magnets, large flux barriers appear near the center axis of the permanent magnets to cause the flux-flow paths to diverge to pass through both side portions of the magnetic pole, so the magnetic flux lines pass through the outer peripheral region A2 of the magnetic pole evenly by effectively using the entirety of outer peripheral region A2, including the right-sided half thereof. With this construction, a flux-flow path MP3 interconnects the adjacent two magnetic poles from the north pole (N pole) of one permanent magnet 16 of the trailing one of the adjacent two magnetic poles to the south pole (S pole) of the adjacent permanent magnet 16 of the leading one of the adjacent two magnetic poles with respect to rotor's rotating direction after passing through the permanent magnet 16 of the trailing magnetic pole from its outer side near the outer periphery of the rotor to its inner side near the inner periphery of the rotor. In a way similar to the flux-flow path MP1, the flux-flow path MP3 extends through the outer peripheral region A2 of the leading magnetic pole with respect to rotor's rotating direction, causing the efficiency of decentralization of the magnetic flux lines to become high.

For this reason, it is suitable for a rotor 12 to adopt, as the construction of burying permanent magnets 16 of each pair forming a magnetic pole, the configuration in which the permanent magnets 16 of the pair are localized outward toward their remotest both ends (radially outer ends of the magnetic pole) while maintaining the “V” shape configuration of the permanent magnets 16 in order not to interfere with the distribution of magnetic flux lines ψᵣ which create reluctance torque Tᵣ. Further, it is suitable to adopt the construction in which flux barriers 17c are formed between the permanent magnets 16 of the pair (radially inner ends of the magnetic pole) to restrict the short-circuit path of magnetic flux lines. In addition, it is suitable to adopt the construction in which a center groove 21 is located on each of the direct axes within the outer periphery surface of rotor 12 to restrict formation of saturation of magnetic flux lines ψᵣ by stator windings coming from the stator teeth 15 of stator 11 or in other words to diverge the magnetic flux lines ψᵣ by stator windings. By adopting such constructions, the rotor 12 is enabled to positively utilize reluctance torque Tᵣ by separating the quadrature axis flux-flow paths (magnetic flux lines) to increase quadrature axis inductance L_{q}.

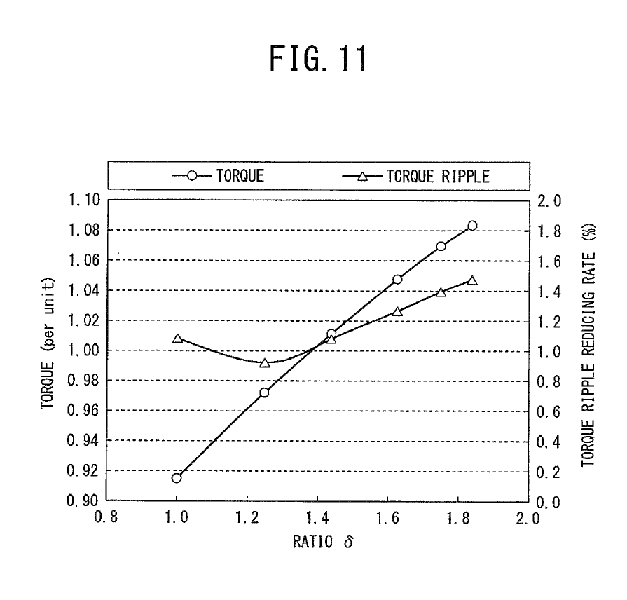

Specifically, it is determined by varying a ratio δ given by calculating the following equation (3), where a pole number P is fixed, an outer radius R1 extending from the axis of rotor 12 to its outer periphery is fixed and the length Wₚₘ of each of permanent magnets 16 of a pair placed at outer end portion of a magnetic pole is made variable, that is, the position of each of inner ends of the permanent magnets 16 the pair is varied. As determining factors of the ratio, the variation in per-unit value of torque T under maximum load condition against the ratio δ and the variation in reduction rate of the fluctuation of this torque T, i.e. torque ripple, against the ratio δ are given after magnetic field analysis and graphically represented as shown by plots in FIG. 11. In the per-unit system, for example, 1.0 [per unit] means that quantity is equivalent to a base unit.

δ=(P×Wₚₘ)/R1 (3)

In FIG. 11, the ratio δ is 1.84 (δ=1.84) to represent the case in which each of permanent magnets 16 has the shape dimension that a length Wₚₘ of the permanent magnet 16 is not reduced (i.e. a reduction in the volume of permanent magnet material is 0%). It is seen that, when the shape dimension satisfies that the ratio δ=1.38 (i.e. a reduction in the volume of permanent magnet material is 24.7%), the torque T produced is equivalent to the torque produced by the rotor 12A of the associated technology having permanent magnets 16 which are not reduce in the length Wₚₘ (i.e. torque T is 1.0 [per unit]). With the permanent magnets 16, if the ratio δ is 1.38 (δ=1.38), the same torque is produced during operation even at low speeds under low load conditions, which is regularly used.

In FIG. 11, the rotor 12A of the associated technology is used to compare. In this comparative rotor 12A, each set of openings 17 located in “V” shape configuration defines, on its radially outer and inner ends, outer and inner flux barriers 17b and 17d of the same size. By contrast, the rotor 12 according to the present embodiment effectively divides and separates the magnetic flux lines ψᵣ by stator windings into two owing to the provision of flux barriers 17c and a center groove 21 per one magnetic pole. This causes the rotor 12 to effectively produce reluctance torque Tᵣ, restraining torque ripple while improving torque T at the ratio δ=1.84 when the length Wₚₘ of each of the permanent magnets 16 is not reduced, i.e. the permanent magnets 16 are equal, in length Wₚₘ, to those of the rotor 12A. In other words, FIG. 11 depicts variation in torque T and that in torque ripple with different values of ratio δ when the length Wₚₘ of each of permanent magnets 16 is reduced in the construction of the rotor 12 according to the present embodiment. It is assumed that there occurs no appreciable variation in torque T, i.e. torque T remains substantially 1.0 [per unit], over the range of ratio δ from 1.84 to the neighborhood of 1.38 when the length Wₚₘ of each of permanent magnets 16 is reduced in the construction of the rotor 12A of the associated technology.

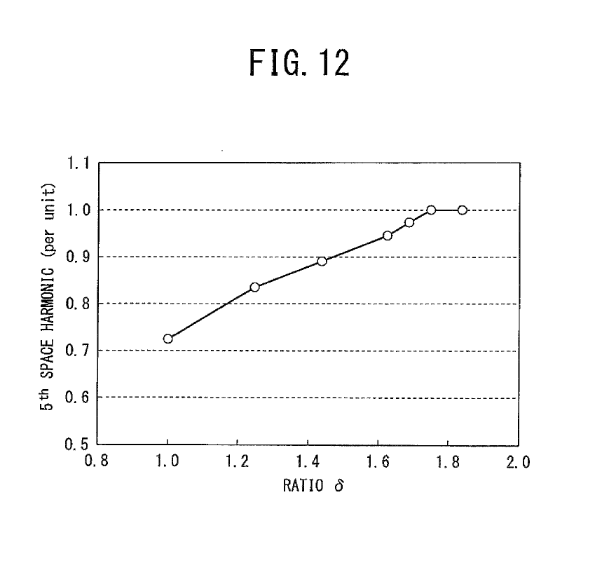

In electric rotating machines, with rotation of a rotor, there occurs superimposition of space harmonics due to magnetostriction derived from field weakening upon generation of an induced voltage (i.e. a reverse voltage) variable, in amplitude, with the usage of embedded permanent magnets. The space harmonics cause an increase in iron loss because the 5^{th}, 7^{th}, 11^{th} and 13^{th} space harmonics cause generation of torque ripple. Generation of 5^{th} space harmonic is graphically represented per unit against ratio δ as shown in FIG. 12. It is seen from FIG. 12 that the less the ratio δ becomes from 1.75 (δ=1.75), the more generation of 5^{th} space harmonic is reduced. In this case, the usage of permanent magnets 16 is reduced by 4.7% or more, and generation of heat is reduced by restricting eddy current within permanent magnets 16 in addition to an improvement in efficiency derived from a reduction in core loss by reducing space harmonics caused by magnetostriction.

From this, it follows that, in the rotor 12 according to the present embodiment, in order to reduce the volume of permanent magnet material used to make the permanent magnets 16 while maintaining output of torque as high as the rotor 12A of the associated technology, it is preferable that the ratio δ is set to about 1.38, i.e. δ≈1.38, by reducing the length Wₚₘ of each of the permanent magnets 16 (a reduction in the volume of permanent magnet material by 24.7%). This reduces torque ripple as well. In conclusion, the shape dimension of each of the permanent magnets 16 may be chosen as appropriate for a desired characteristic of output of torque T and torque ripple so that the ratio δ falls in a range from δ=1.38 (a reduction in the volume of permanent magnet material: 24.7%) to δ=1.75 (a reduction in the volume of permanent magnet material: 4.7%).

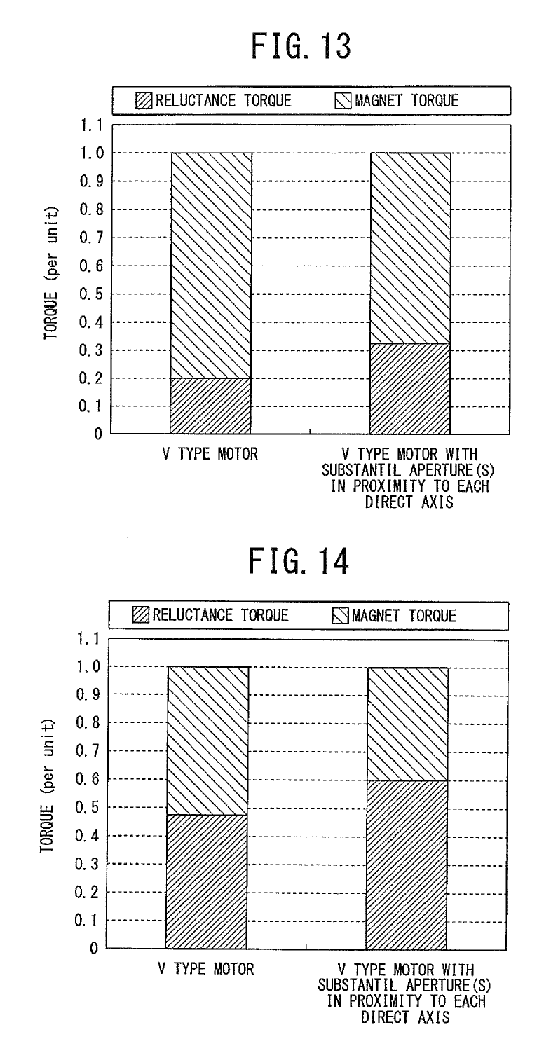

Magnetic analysis of two different IPM motors capable of producing the same torque, one motor in which its permanent magnets 16 of each pair located in “V” shape configuration are reduced in length Wₚₘ to leave openings near each direct axis (d-axis) to provide such a shape dimension that the ratio δ is 1.38, the other motor in which its permanent magnets 16 of each pair located in “V” shape configuration are not reduced, reveals that, as shown in FIGS. 13 and 14, the electric rotating machine 10 generate substantially the same torque T if the ratio of the reluctance torque Tᵣ to the magnet torque Tₘ is varied. The IPM motor of the V-shape type with openings near each direct axis is configured to have flux barriers 17c occupying large apertures located near each direct axis, while the IPM motor of the mere V-shape type is configured to have flux barriers 17d occupying small apertures located near each direct axis.

FIG. 13 shows a ratio between torque Tₘ and torque Tᵣ during operation in low load range, while FIG. 14 shows a ratio between torque Tₘ and torque Tᵣ during operation in the maximum load range. In both of the load ranges, FIGS. 13 and 14 reveal that, in the case of the IPM motor of the V-shape type with large apertures near each direct axis, the ratio of reluctance torque Tᵣ grows for a reduction in the ratio of magnet torque Tₘ caused by a reduction in the length of each permanent magnet 16. Within a small region A1 located near the outer circumference of each pole as shown in FIGS. 6B and 7, by forming flux barriers 17c occupying large apertures in substitution for permanent magnets 16 near the direct axis and a center groove 21 as well, the magnetic flux lines ψₘ by magnets which counteracts the magnetic flux lines ψᵣ by stator windings is reduced. This results in an increase in the quadrature axis (q-axis) inductance L_{q}, causing a difference between the quadrature axis (q-axis) inductance L_{q} and the direct axis inductance L_{d} (or the saliency ratio) to become greater than that (or the saliency ratio) of the IPM motor of the V-shape type with unreduced permanent magnets, enabling the electric rotating machine 10 to provide the equivalent torque by effectively utilizing the reluctance torque Tᵣ.

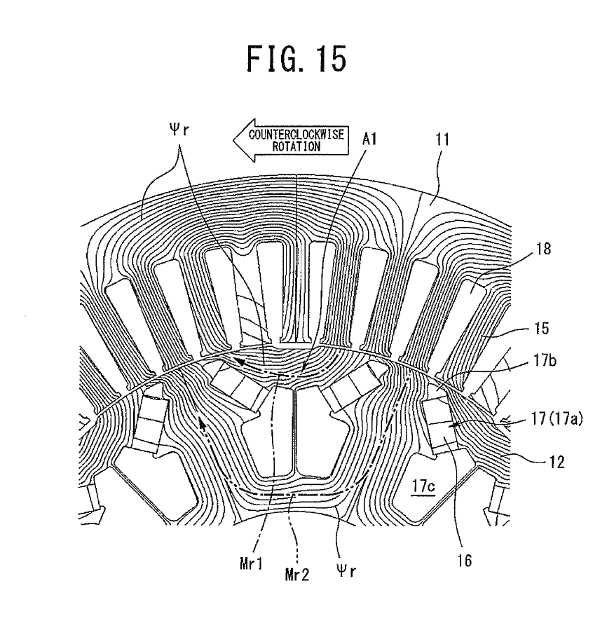

As shown by the flux-flow distribution in FIG. 15, this construction allows the electric rotating machine 10 to divert (separate) effectively some of the magnetic flux lines ψᵣ by stator windings which are concentrated on the small region A1 located radially outward of permanent magnets of each pair forming a magnetic pole, from the flux-flow path Mᵣ1, which runs through the radially outward small region A1, into the flux-flow path Mᵣ2, which passes around the radially inward side of apertures 17c, located near the direct axis, of a set of openings located in “V” shape configuration. As a result, the electric rotating machine 10 reduces magnetic interaction between magnetic flux lines ψₘ by magnets and magnetic flux lines ψᵣ by stator windings (d-axis, q-axis) to avoid local magnetic saturation in the leading side, with respect to direction of rotation, of the radially outward small region A1 of the magnetic pole, rendering them effective in contributing to generation of torque T.

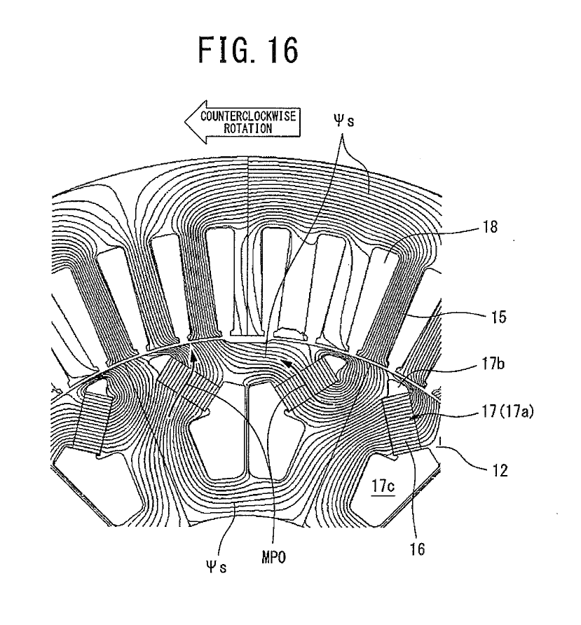

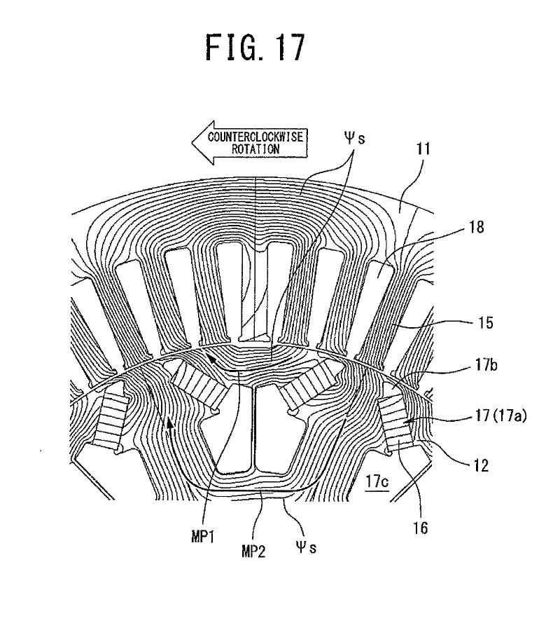

Therefore, as illustrated by the flux-flow distribution in FIG. 16, most of synthetic magnetic flux lines ψₛ developed by combined effect of magnetic flux lines ψₘ by magnets and magnetic flux ψᵣ by stator windings pass through flux-flow paths MPO extending through the permanent magnets 16 of each pair when the electric rotating machine 10 is operating under low load conditions in a motoring mode, while, as illustrated by the flux-flow distribution in FIG. 17, the synthetic magnetic flux lines ψₛ split into a flux-flow path MP1 and a flux-flow path MP2 when it is operating under the maximum load in motoring mode. As a result, the electric rotating machine 10 implements avoidance of local magnetic saturation together with a reduction in magnetic interaction to generate efficiently the same or a greater level of torque T than the IPM motor of the V-shape type having unreduced permanent magnets while attaining a reduction in the volume of permanent magnet material of the permanent magnets 16. During operation under low load conditions in a motoring mode, the magnetic flux lines ψₘ by magnets account for a high percentage in the synthetic magnetic flux lines ψₛ as compared to the magnetic flux lines ψᵣ by stator windings.

If, with the permanent magnets 16 having the geometry expressed, for example, as the ratio δ=1.44, the volume of permanent magnet material is reduced by 23% to be replaced with flux barriers 17c having low magnetic permeability (a reduction in permanent magnet flux ψₘ), a reduction of about 13.4% in back-emf constant accompanied by a reduction in inertia makes it possible for the electric rotating machine 10 to have its power output to increase at high rotational speeds. Besides, a reduction in space harmonics, which causes magnetostriction, reduces heat and iron loss in the permanent magnets 16 due to eddy currents and restrains electromagnetic noise.

Thus, according to the present embodiment, since large flux barriers 17 are substituted after removing those portions of each of the plurality pairs of permanent magnets 16 located in the predetermined ranges B on the side of a direct axis, magnetic rotor flux and magnetic stator flux do not interact with each other (or cancel each other) on the side of the direct axis by eliminating the magnetic rotor flux ψₘ emitted in directions to act against (cancel) the magnetic stator flux ψᵣ, and the passage of magnetic stator flux through predetermined ranges on the side of the direct axis is restricted.

Therefore, there are obtained a substantial increase in magnet torque Tₘ and in reluctance torque Tᵣ by effectively using magnetic stator flux ψᵣ and magnetic rotor flux ψₘ on the side of the direct axis while reducing the usage of permanent magnets. In addition, an increase in output power at high speeds is made owing to a reduction in induced voltage constant and a low cost is provided by lowering heat restraint grade resulting from restraining generation of heat of the permanent magnets 16 derived from eddy current and restraining demagnetization caused by temperature change.

Consequently, there is realized a low cost electric rotating machine which provides high quality operation in a motoring mode with high energy density.

Having described the present embodiment taking the electric rotating machine 10 in the form of an 8-pole 48-slot motor as an example, it is noted that the present invention is not limited to this embodiment and may be preferably applied to any structure having a slot per phase per pole value q is 2, i.e., q=2. For example, the present invention may be applied to motor structure of 6-pole 36-slot or 4-pole 24-slot or 10-pole 60-slot without any modification.

The present invention is not limited to the exemplary embodiment described and illustrated, but it encompasses all of embodiments which provide equivalent effects to what the present invention aims at. Further, the present invention is not limited to combinations of features of the subject matter defined by every claim, but it is defined by all of any desired combinations of specific ones of all of disclosed features.

Having described in the preceding one embodiment according to the present invention, the present invention is not limited to the above-mentioned embodiment, but may be implemented in various forms within the technical ideas of the present invention.

1. An interior permanent magnet (IPM) electric rotating machine, comprising:
a stator adapted for receiving stator windings;
a rotor rotatable relative to the stator;
permanent magnets in the rotor forming magnetic poles; and
apertures with a low permeability, each being substituted for that portion of one of the permanent magnets located in a predetermined range which would generate magnetic flux lines in such directions as to cancel magnetic flux lines emanating from the stator in the neighborhood of a direct axis of one of the magnetic poles if the permanent magnet were located in the predetermined range.

2. The IPM electric rotating machine according to claim 1, wherein:
when a slot per phase per pole value P is 2, q=2, the rotor is selected to satisfy the equality expressed as:
1.38≦(P×Wₚₘ)/R<1.84,
where; Wₚₘ is the dimension of each of said permanent magnets in radial direction of said rotor, R is the radius of said rotor to its periphery and P is the slot per phase per pole value.
